(19) United States
(12) Patent Application Publication
(10) Pub. No.: US 2012/0325201 A1
(43) Pub. Date: Dec. 27, 2012

(54) SOLAR REFLECTIVE CONDENSING DEVICE

(75) Inventor: Daren DENG, Tianjin (CN)

(73) Assignee: TIANJIN TAIYANGSHEN TECHNOLOGY CO., LTD., Tianjin (CN)

(21) Appl. No.: 13/600,254

(22) Filed: Aug. 31, 2012

Related U.S. Application Data
(63) Continuation-in-part of application No. PCT/CN2011/071121, filed on Feb. 21, 2011.

(30) Foreign Application Priority Data
Mar. 2, 2010 (CN) 201010115538.9

(51) Int. Cl. F24J 2/12; G02B 5/10

(52) U.S. Cl. 126/694; 359/853

(57) ABSTRACT

A solar reflective condensing device, including a condensing film (2), a face-contour bottom plate (3), and a face-contour focusing support (4). The condensing film (2) is arranged on a top surface of the face-contour bottom plate (3). The face-contour bottom plate (3) is a thin plate, a bottom surface of which is attached to a top surface of the face-contour focusing support (4), and reproduces the shape of the top surface of the face-contour focusing support (4). The face-contour focusing support (4) includes a top optical surface (4a) and a focusing structure (4b) integrated with the face-contour focusing support. The top optical surface (4a) is positioned on the top surface of the face-contour focusing support (4), and a central point of the focusing structure (4b) integrated with the face-contour focusing support is positioned at a focus (f) of the top optical surface (4a).

### CROSS-REFERENCE TO RELATED APPLICATIONS

This application is a continuation-in-part of International Patent Application No. PCT/CN2011/071121 with an international filing date of Feb. 21, 2011, designating the United States, now pending, and further claims priority benefits to Chinese Patent Application No. 201010115538.9 filed Mar. 2, 2010. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a solar reflective condensing device.

2. Description of the Related Art

A typical solar reflective condensing device includes three elements: a reflective coating layer (condensing layer) with an extremely high reflection coefficient; a reflecting profile meeting the optical requirements; and accurate condensing focusing.

For most of existing solar reflective condensing devices, an accurate face-contour is processed on an integral parent material according to the optical requirements, the profile of the face-contour is polished and filmed, and then the photoreceptor is arranged on the focus through a welding support to form a condensing device.

The above condensing device has the following deficiencies: the material cost is high, the processing is difficult, the focus cannot be located accurately, and the mass production is very difficult. So the above condensing device is only used in the laboratory or the revelatory sample project, and cannot be popularized and spread on a large scale, thereby limiting the utilization and development of solar energy.

### SUMMARY OF THE INVENTION

In view of the above-described problems, it is one objective of the invention to provide a solar reflective condensing device which has low cost, is easy to manufacture, has high repeatability precision and good condensing effect and can be popularized on a large scale.

To achieve the above objective, in accordance with one embodiment of the invention, there is provided a solar reflective condensing device comprising: a condensing film, a face-contour bottom plate, and a face-contour focusing support. The condensing film is a planar film with a reflective coating layer which is arranged on a top surface of the face-contour bottom plate; the face-contour bottom plate is a thin plate, a bottom surface of the face-contour bottom plate is attached to a top surface of the face-contour focusing support and reproduces the shape of the top surface of the face-contour focusing support. The face-contour focusing support comprises a top optical surface and a focusing structure integrated with the face-contour focusing support. The top optical surface is positioned on the top surface of the face-contour focusing support, and a central point of the focusing structure integrated with the face-contour focusing support is positioned at the focus of the top optical surface.

In accordance with another embodiment of the invention, there is provided a solar reflective condensing device comprising: a condensing film, a face-contour bottom plate, and a face-contour focusing support. The condensing film is a microprism total reflective condensing film which is arranged on a top surface of the face-contour bottom plate; the face-contour bottom plate is a thin plate, a bottom surface of the face-contour bottom plate is attached to a top surface of the face-contour focusing support and reproduces the shape of the top surface of the face-contour focusing support. The face-contour focusing support comprises a top optical surface and a focusing structure integrated with the face-contour focusing support. The top optical surface is positioned on the top surface of the face-contour focusing support, and a central point of the focusing structure integrated with the face-contour focusing support is positioned at the focus of the top optical surface.

In a class of this embodiment, a heat collection tube is arranged on the solar reflective condensing device so that the heat collection tube becomes the condensing focus capable of collecting the solar heat. The collected solar heat is six to nine times more than the solar heat collected only by the heat collection tube. Thus, the purpose of collecting more heat and heating water at higher temperature (near 100° C.) is achieved, the solar hot water can be used for bathing and heating, and therefore the progress in the utilization of the solar hot water is made.

Advantages of the invention are summarized below:
1. In the invention, the components difficult to process and required to be polished and coated are disintegrated into the condensing film and the face-contour bottom plate, and the disintegrated components are convenient to manufacture and have low costs.
2. In the invention, the profile difficult to process is disintegrated into the face-contour bottom plate and the face-contour focusing support, the face-contour bottom plate is made into the thin plate, the top surface of the face-contour focusing support is only fabricated into the accurate profile necessary for condensing, and the disintegrated face-contour focusing support is easy to accurately process, so that when the flexible face-contour bottom plate is attached to the top surface of the face-contour focusing support, the top surface shape of the face-contour focusing support can be accurate reproduced, and the formation of the low-cost profile which is convenient to process is achieved.
3. In the invention, for solving the problem of accurate focusing, the focusing structure and the face-contour focusing support are fabricated onto one part, and the part is a molded part, so that the problem of accurate repeated focusing is successfully solved.
4. The successful solution of the above three problems ensures that the utilization of the solar reflective condensing can be popularized and spread on a large scale.

### BRIEF DESCRIPTION OF THE DRAWINGS

FIG. 1 is a stereogram of a solar reflective condensing device in accordance with one embodiment of the invention;

FIG. 2 is a front view of FIG. 1;

FIG. 3 is a cross-sectional view taken from line A-A of FIG. 2;

FIG. 4 is a cross-sectional view of a planar film with a reflective coating layer;

FIG. 5 is a schematic diagram of a face-contour focusing support; and

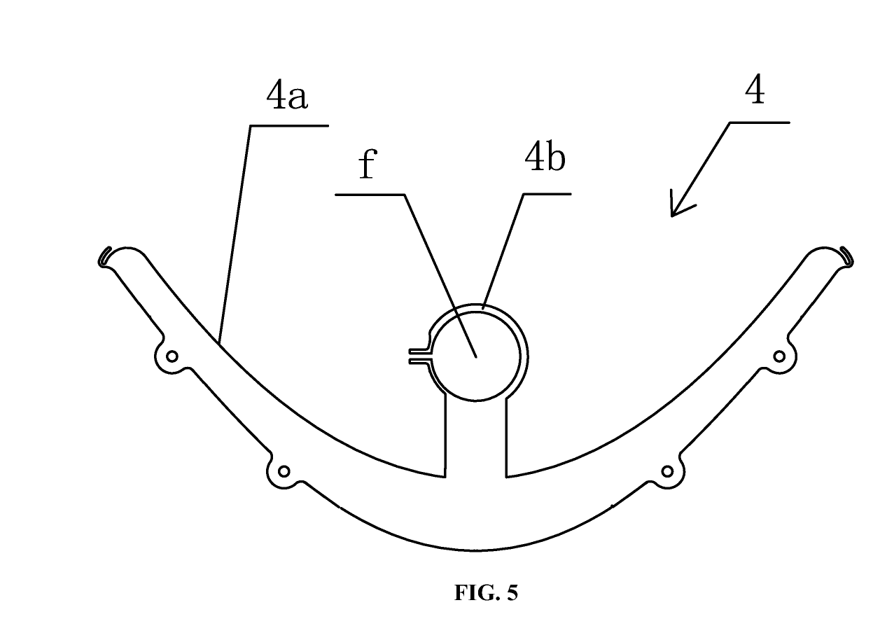

FIG. 6 is a schematic diagram of a microprism total reflective condensing film, and presents an optical path of total reflective of sunlight on the microprism.

In the drawings, the following reference numbers are used: 1. Heat collection tube; 2. Condensing film; 2a. Planar film with the reflective coating layer; 2b. Microprism total reflective condensing film; 3. Face-contour bottom plate; 4. Face-contour focusing support; 4a. Top optical surface; 4b. A focusing structure; 6. Adhesive; 7. Transparent plastic film; 8. Reflective coating layer; 9. Protective film layer; 11. First plane; 12. Digital surface; 14. Second plane; i1, i2, i3. Incident light rays; r1, r2, r3. Reflected light rays; f. Focus.

### DETAILED DESCRIPTION OF THE EMBODIMENTS

To further illustrate the invention, experiments detailing a solar reflective condensing device are described below. It should be noted that the following examples are intended to describe and not to limit the invention.

### Example 1

The invention provides a solar reflective condensing device, which comprises a condensing film 2, a face-contour bottom plate 3, and a face-contour focusing support 4.

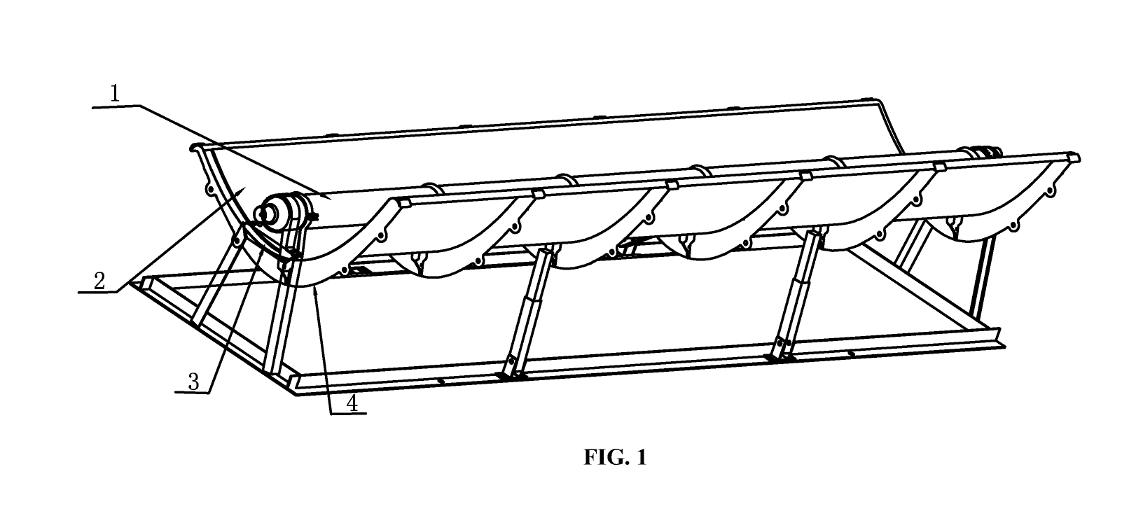

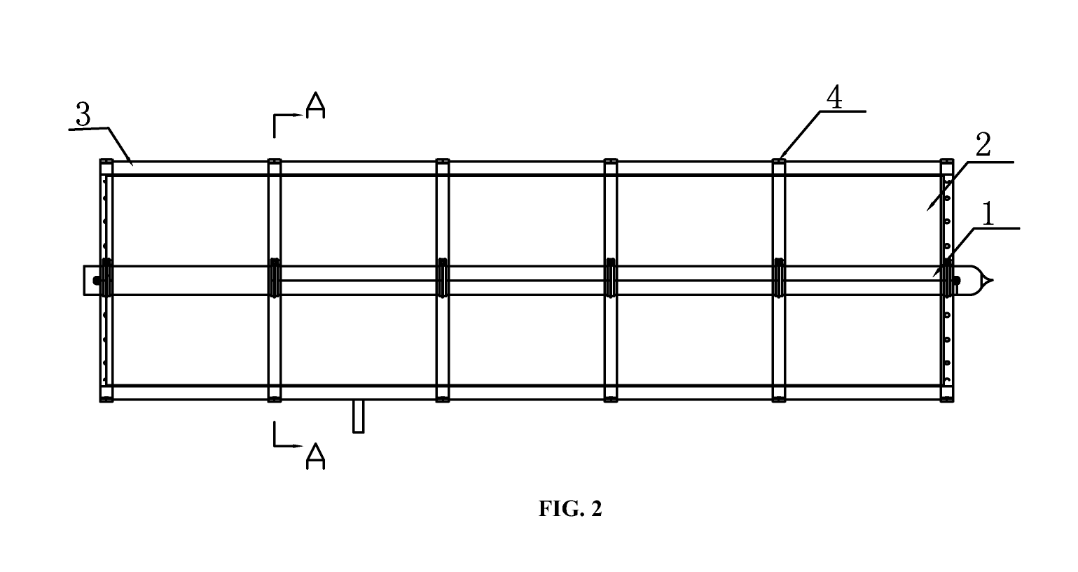

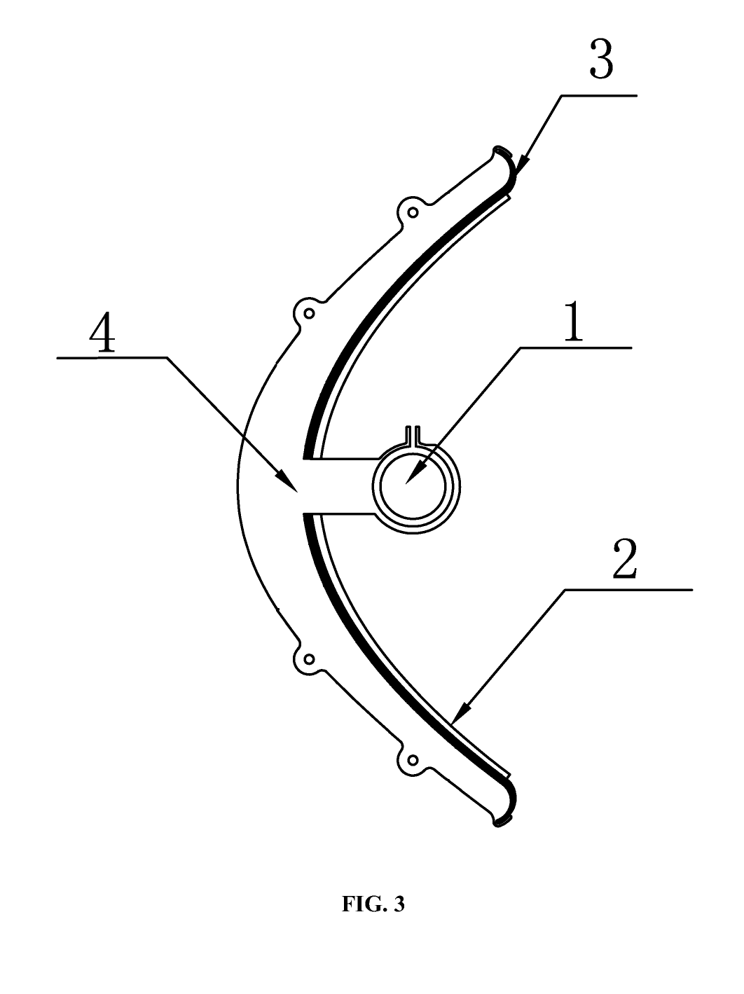

As shown in FIGS. 1-3, the condensing film 2 is a planar film 2a with a reflective coating layer, and the planar film 2a with the reflective coating layer is arranged on the top surface of the face-contour bottom plate 3; the face-contour bottom plate 3 is a thin plate, the bottom surface of the face-contour bottom plate 3 is attached to the top surface of the face-contour focusing support 4 and reproduces the shape of the top surface of the face-contour focusing support 4.

The face-contour focusing support 4 comprises a top optical surface 4a and a focusing structure 4b integrated with the face-contour focusing support. The top optical surface 4a is positioned on the top surface of the face-contour focusing support 4, and the central point of the focusing structure 4b integrated with the face-contour focusing support is positioned at the focus f of the top optical surface 4a.

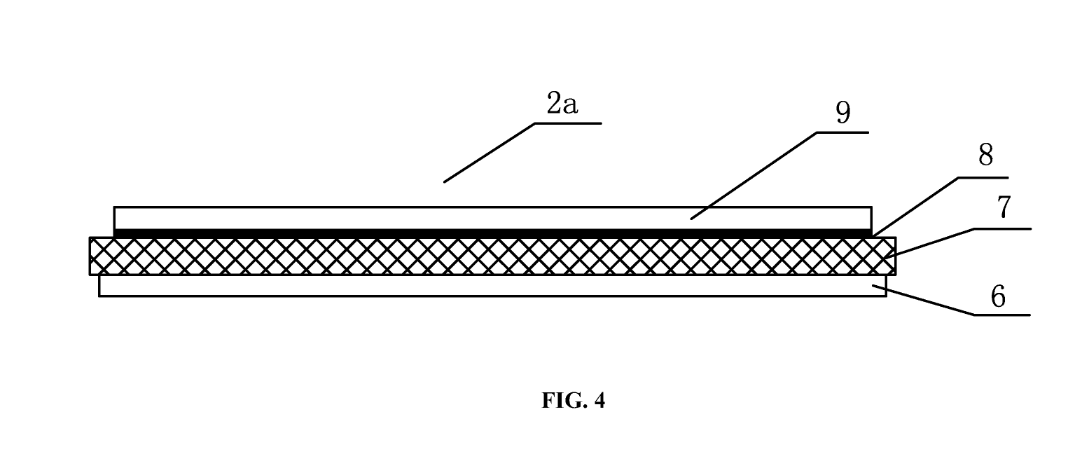

As shown in FIG. 4, the planar film 2a with the reflective coating layer adopts the following structure: the reflective coating layer 8 is coated on one side surface of a transparent plastic film 7, and a protective film layer 9 is coated on the reflective coating layer 8; an adhesive 6 is coated on the other side surface of the transparent plastic film 7.

When the condensing film 2 is the planar film 2a with the reflective coating layer, the face-contour bottom plate 3 is paraboloidal.

When the condensing film 2 is the planar film 2a with the reflective coating layer, the top optical surface 4a is a parabolic cylinder; the top optical surface 4a and the focusing structure 4b integrated with the face-contour focusing support adopt the integrated structure or the accurately positioning mechanical connecting structure.

The solar reflective condensing device further comprises a heat collection tube 1, and the center of the heat collection tube 1 coincides with the central point of the focusing structure 4b integrated with the face-contour focusing support.

The fabrication process of the solar reflective condensing device of the example is as follows:

The face-contour focusing support 4 with the top surface being the accurate paraboloid is first manufactured, and then the thin face-contour bottom plate 3 with the thickness smaller than 0.5 mm is attached to the upper surface of the face-contour focusing support 4, so that the flexible face-contour bottom plate 3 accurately reproduces the upper paraboloid shape of the face-contour focusing support 4; the planar film 2a with the reflective coating layer is smoothly stuck to the upper surface of the face-contour bottom plate 3, and then the heat collection tube 1 is inserted into the hole of the focusing structure 4b integrated with the face-contour focusing support on the face-contour focusing support 4, so that the solar reflective condensing device of the invention is completed.

### Example 2

The invention provides a solar reflective condensing device, which comprises a condensing film 2, a face-contour bottom plate 3, and a face-contour focusing support 4.

As shown in FIGS. 1, 2, and 3, the condensing film 2 is a microprism total reflective condensing film 2b, and the microprism total reflective condensing film 2b is arranged on the top surface of the face-contour bottom plate 3; the face-contour bottom plate 3 is a thin plate, the bottom surface of the face-contour bottom plate 3 is attached to the top surface of the face-contour focusing support 4 and reproduces the shape of the top surface of the face-contour focusing support 4.

The face-contour focusing support 4 comprises a top optical surface 4a and a focusing structure 4b integrated with the face-contour focusing support. The top optical surface 4a is positioned on the top surface of the face-contour focusing support 4, and the central point of the focusing structure 4b integrated with the face-contour focusing support is positioned at the focus f of the top optical surface 4a.

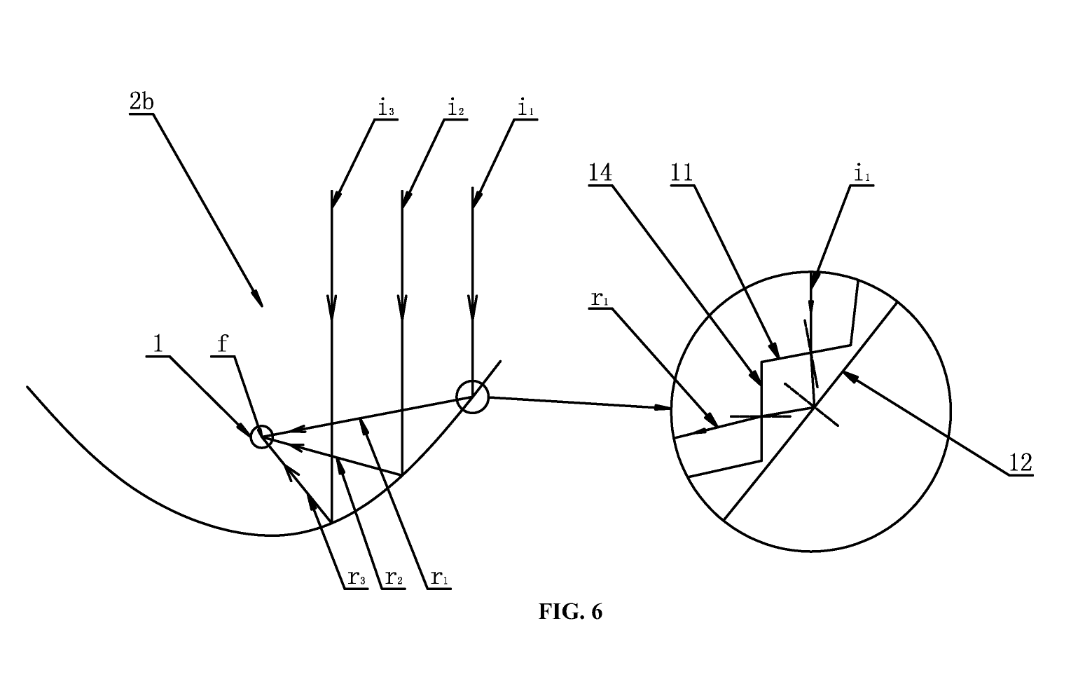

FIG. 6 is a structural representation of the microprism total reflective condensing film. The microprism total reflective condensing film 2b adopts the structure: a plurality of microprisms are formed on the transparent plastic film.

When the condensing film 2 is the microprism total reflective condensing film 2b, the shape of the face-contour bottom plate 3 ensures that not only the prisms on the microprism total reflective condensing film 2b meets the total reflection condition, but also the reflected light rays are focused on one focus f.

When the condensing film 2 is the microprism total reflective condensing film 2b, the top optical surface 4a is a digital cylinder, and the digital cylinder adopts the structure: the incident light rays i1, i2, and i3 parallel to the optical axis fall on the digital surface 12 after being refracted by a first plane 11, and then totally reflected to a second plane 14 by the digital surface 12, and the reflected light rays r1, r2, and r3 after being refracted by the second plane 14 are focused on the same focus f.

The solar reflective condensing device further comprises a heat collection tube 1, and the center of the heat collection tube 1 coincides with the central point of the focusing structure 4b integrated with the face-contour focusing support.

The fabrication process of the solar reflective condensing device of the example is as follows:

The face-contour focusing support 4 with the top surface being the accurate digital surface 12 is first manufactured, and then the thin face-contour bottom plate 3 with the thickness smaller than 0.5 mm is attached to the upper surface of the face-contour focusing support 4, so that the flexible face-contour bottom plate 3 accurately reproduces the upper digital surface 12 shape of the face-contour focusing support 4; microprism total reflective condensing film 2b is smoothly stuck to the upper surface of the face-contour bottom plate 3, and then the heat collection tube 1 is inserted into the hole of the focusing structure 4b integrated with the face-contour focusing support on the face-contour focusing support 4, so that the solar reflective condensing device of the invention is completed.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A solar reflective condensing device, comprising:
a) a condensing film (2);
b) a face-contour bottom plate (3); and
c) a face-contour focusing support (4);
wherein:
the condensing film (2) is a planar film (2a) with a reflective coating layer arranged on a top surface of the face-contour bottom plate (3);
the face-contour bottom plate (3) is a thin plate, a bottom surface of which is attached to a top surface of the face-contour focusing support (4) and corresponds to the shape of the top surface of the face-contour focusing support (4);
the face-contour focusing support (4) comprises a top optical surface (4a) and a focusing structure (4b) integrated with the face-contour focusing support; and
the top optical surface (4a) is positioned on the top surface of the face-contour focusing support (4), and a central point of the focusing structure (4b), which is integrated with the face-contour focusing support, is positioned at a focus (f) of the top optical surface (4a).

2. The device of claim 1, wherein the planar film (2a) with the reflective coating layer comprises the following structure:
a reflective coating layer (8) is coated on one side surface of a transparent plastic film (7), and a protective film layer (9) is coated on the reflective coating layer (8); and
an adhesive (6) is coated on the other side surface of the transparent plastic film (7).

3. The device of claim 1, wherein the face-contour bottom plate (3) is paraboloidal.

4. The device of claim 1, wherein
the top optical surface (4a) is a parabolic cylinder; and
the top optical surface (4a) and the focusing structure (4b) integrated with the face-contour focusing support are an integrated structure or an accurately positioning mechanical connecting structure.

5. The device of claim 1, further comprising a heat collection tube (1), and a center of the heat collection tube (1) coinciding with the central point of the focusing structure (4b) integrated with the face-contour focusing support.

6. A solar reflective condensing device, comprising:
a) a condensing film (2);
b) a face-contour bottom plate (3); and
c) a face-contour focusing support (4);
wherein
the condensing film (2) is a microprism total reflective condensing film (2b) arranged on a top surface of the face-contour bottom plate (3);
the face-contour bottom plate (3) is a thin plate, a bottom surface of which is attached to a top surface of the face-contour focusing support (4) and corresponds to the shape of the top surface of the face-contour focusing support (4);
the face-contour focusing support (4) comprises a top optical surface (4a) and a focusing structure (4b) integrated with the face-contour focusing support; and
the top optical surface (4a) is positioned on the top surface of the face-contour focusing support (4), and a central point of the focusing structure (4b), which is integrated with the face-contour focusing support, is positioned at a focus (f) of the top optical surface (4a).

7. The device of claim 6, wherein the microprism total reflective condensing film (2b) comprises the following structure: a plurality of microprisms are formed on a transparent plastic film.

8. The device of claim 6, wherein the face-contour bottom plate (3) has a shape ensuring that not only prisms on the microprism total reflective condensing film (2b) meet the total reflection condition, but also that reflected light rays are focused on one focus (f).

9. The device of claim 6, wherein the top optical surface (4a) is a digital cylinder, and the digital cylinder comprises the following structure: incident light rays (i1, i2, and i3) parallel to an optical axis fall on a digital surface (12) after being refracted by a first plane (11), and then totally reflected to a second plane (14) by the digital surface (12), and reflected light rays (r1, r2, and r3) after being refracted by the second plane (14) are focused on the same focus (f).

10. The device of claim 6, further comprising a heat collection tube (1), wherein a center of the heat collection tube (1) coincides with the central point of the focusing structure (4b) integrated with the face-contour focusing support.
